(19) United States
(12) Patent Application Publication
(10) Pub. No.: US 2015/0189558 A1
(43) Pub. Date: Jul. 2, 2015

(54) METHOD AND APPARATUS FOR WIRELESS COMMUNICATION IN A HETEROGENOUS NETWORK

(71) Applicant: Nokia Corporation, Espoo (FI)

(72) Inventors: Rinne Mika, Espoo (FI); Yang Liu, Beijing (CN); Haitao Li, Beijing (CN); Seppo Ilmari Vesterinen, Oulunsalo (FI); Vesely Alexander, Feldbach (AT)

(21) Appl. No.: 14/419,582

(22) PCT Filed: Aug. 21, 2012
(86) PCT No.: PCT/CN2012/080403

§ 371 Date: Mar. 3, 2015

(51) Int. Cl. H04W 36/00; H04W 76/04; H04W 48/16

(52) U.S. Cl. CPC H04W 36/0066; H04W 48/16; H04W 76/046

(57) ABSTRACT

A method, corresponding apparatuses, and a computer program product for wireless communication in a heterogeneous network are provided. The method comprises detecting, by a user equipment in a wireless wide area network, availability of a wireless local area network. The method also comprises transferring into a wireless local area network available state if the wireless local area network is available. The method additionally comprises transferring into a wireless local area network unavailable state if the wireless local area network is unavailable. In the method, the transferring into the wireless local area network available or unavailable state is independent of a concurrent radio resource control state of the user equipment. With the claimed inventions, good coordination of the radio resource control states in the heterogeneous network can be realized without affecting radio resource control of legacy networks.

### FIELD OF THE INVENTION

Embodiments of the present invention generally relate to wireless communication techniques including the 3GPP (the 3rd Generation Partnership Project) LTE (Long Term Evolution) technique. More particularly, embodiments of the present invention relate to a method, an apparatus, and a computer program product for wireless communication in a heterogeneous network.

### BACKGROUND OF THE INVENTION

Various abbreviations that appear in the specification and/or in the drawing figures are defined as below:

ANDSF Access Network Discovery and Selection Function

AP Access Point

BS Base Station

CN Core Network

eLAN enhanced Local Area Network

eNB evolved Node B

EPS Enhanced Packet System

EPC Enhanced Packet Core

EUTRAN Evolved Universal Terrestrial Radio Access Network

ECM EPS Connection Management

GPRS General Packet Radio Service

GW Gateway

HLR Home Location Register

HSS Home Subscriber Server

IP Internet Protocol

LAN Local Area Network

MME Mobility Management Entity

MSC Mobile Switching Centre

NAS Non Access Stratum

OAM Operations, Administrations and Maintenance

PDU Protocol Data Unit

PDN Packet Data Network

PLMNID Public Land Mobile Network Identification

RNC Radio Network Controller

RRC Radio Resource Control

RRM Radio Resource Management

SDU Service Data Unit

UE User Equipment

VLR Visitor Location Register

WAN Wide Area Network

The following description of background art may include insights, discoveries, understandings or disclosures, or associations together with disclosures not known to the relevant art prior to the present invention but provided by the present invention. Some such contributions of the present invention may be specifically pointed out below, while other such contributions of the present invention will be apparent from their context.

As the number of persons using wireless communication in their daily life keeps increasing, high-speed data transmissions have become highly expected to meet the requirements of a multitude of wireless services. It is known that a LAN system is generally capable of providing relatively high speed data services. How to provide local access with a high speed data rate using a wireless communication system, e.g., an LTE system or an EPS, has become a hot topic in the 3GPP. This kind of local access may either compete with or complement other wireless local access techniques.

### SUMMARY OF THE INVENTION

The following presents a simplified summary of the present invention in order to provide a basic understanding of some aspects of the present invention. It should be noted that this summary is not an extensive overview of the present invention and that it is not intended to identify key/critical elements of the present invention or to delineate the scope of the present invention. Its sole purpose is to present some concepts of the present invention in a simplified form as a prelude to the more detailed description that is presented later.

One embodiment of the present invention provides a method. The method comprises detecting, by a UE in a wireless WAN, availability of a wireless LAN. The method also comprises transferring into a wireless LAN available state if the wireless LAN is available. The method additionally comprises transferring into a wireless LAN unavailable state if the wireless LAN is unavailable. In the method, the transferring into the wireless LAN available or unavailable state is independent of a concurrent RRC state of the UE.

In one embodiment, the transferring into the wireless LAN available state comprises one of camping on the wireless LAN and activating a wireless local area service provided by the wireless LAN.

In an additional embodiment, the method further comprises transferring, subsequent to the activating the wireless local area service provided by the wireless LAN, into a drift mode which is independent of the concurrent RRC state of the UE.

In another embodiment, the method comprises transferring, subsequent to deactivating the activated wireless local area service, into the wireless LAN available state.

In yet another embodiment, the detecting availability of the wireless LAN comprises detecting the wireless LAN based upon a predetermined identifier or assistance information from the wireless WAN.

In a further embodiment, the RRC state of the UE is one of an RRC connected state and an RRC idle state in the wireless WAN.

In an additional embodiment, the method comprises receiving, via the wireless LAN, system information from the wireless WAN and activating, based upon the system information, a wireless wide area service to transfer into the RRC connected state. The method further comprises at least one of the following: directly transmitting to or receiving from the wireless WAN the wireless wide area service, and indirectly transmitting to or receiving from the wireless WAN the wireless wide area service at least partly via the wireless LAN.

In one embodiment, the method further comprises activating a wireless wide area service via a direct connection with the wireless WAN to transfer into the RRC connected state and transferring into the wireless LAN available state by activating the wireless local area service. The method further comprises at least one of the following: directly transmitting to or receiving from the wireless WAN the wireless wide area service, and indirectly transmitting to or receiving from the wireless WAN the wireless wide area service at least partly via the wireless LAN.

In a further embodiment, the wireless wide area service is related to at least one RRC transaction and indirectly transmitted to or received from the wireless WAN via the wireless LAN, and the method comprises maintaining, in response to disconnecting the wireless LAN from the wireless WAN, at least one RRC transaction by mapping or changing an identifier thereof.

In an embodiment, the method further comprises activating a wireless wide area service via a direct connection with the wireless WAN to transfer into the RRC connected state. The method further comprises one of the following: transferring into the wireless LAN unavailable state and transferring into the wireless LAN available state.

In yet another embodiment, the method further comprises activating a wireless wide area service via the wireless LAN to transfer into the RRC connected state and performing, prior to disconnecting from the wireless LAN, an RRC connection release procedure with the wireless WAN if no wide area cell is detected.

In a further embodiment, the method further comprises deactivating the activated wireless wide area service via the wireless LAN to transfer into the RRC idle state. The method further comprises one of the following: transferring into the wireless LAN available state and transferring into the wireless LAN unavailable state.

In another embodiment, wherein the wireless LAN is an eLAN constructed under an LTE system and comprises at least one wireless local area AP for serving the UE, and the wireless WAN is an LTE network or an EPS network and comprises at least one macro eNode B.

One embodiment of the present invention provides an apparatus. The apparatus comprises means for detecting, by a UE in a wireless WAN, availability of a wireless LAN. The apparatus also comprises means for transferring into a wireless LAN available state if the wireless LAN is available. The apparatus additionally comprises means for transferring into a wireless LAN unavailable state if the wireless LAN is unavailable. In the apparatus, the transferring into the wireless LAN available or unavailable state is independent of a concurrent RRC state of the UE.

A further embodiment of the present invention provides an apparatus. The apparatus comprises at least one processor and at least one memory including computer program instructions. The at least one memory and computer program instructions are configured to, with the at least one processor, cause the apparatus at least to detect, by a UE in a wireless WAN, availability of a wireless LAN. The at least one memory and computer program instructions are also configured to, with the at least one processor, cause the apparatus at least to transfer into a wireless LAN available state if the wireless LAN is available. The at least one memory and computer program instructions are additionally configured to, with the at least one processor, cause the apparatus at least to transfer into a wireless LAN unavailable state if the wireless LAN is unavailable. In the apparatus, the transferring into the wireless LAN available or unavailable state is independent of a concurrent RRC state of the UE.

One embodiment of the present invention provides a computer program product, comprising at least one computer readable storage medium having a computer readable program code portion stored thereon. The computer readable program code portion comprises program code instructions for detecting, by a UE in a wireless WAN, availability of a wireless LAN. The computer readable program code portion also comprises program code instructions for transferring into a wireless LAN available state if the wireless LAN is available. The computer readable program code portion also comprises program code instructions for transferring into a wireless LAN unavailable state if the wireless LAN is unavailable. The transferring into the wireless LAN available or unavailable state is independent of a concurrent RRC state of the UE.

### BRIEF DESCRIPTION OF THE DRAWINGS

The embodiments of the present invention that are presented in the sense of examples and their advantages are explained in greater detail below with reference to the accompanying drawings, in which:

FIG. 1 illustrates an exemplary heterogeneous network including an LTE-LAN network and a legacy LTE or EPS network in which the embodiments of the present invention can be practiced;

FIG. 2 schematically illustrates state transitions of a UE in the heterogeneous network as illustrated in FIG. 1, including corresponding changes of RRC states, according to an embodiment of the present invention;

FIG. 3 schematically illustrates state transitions of a UE in the heterogeneous network, in which a drift mode is introduced, according to an embodiment of the present invention;

FIGS. 4a-4b schematically illustrate alternatives regarding state transitions of the UE as illustrated in FIG. 2 according to embodiments of the present invention;

FIG. 5 is a flow chart schematically illustrating a method for wireless communication in the heterogeneous network, e.g., as illustrated in FIG. 1, according to an embodiment of the present invention;

FIG. 6 is a flow chart schematically illustrating a method for wireless communication in the heterogeneous network according to the embodiments of the present invention; and

FIG. 7 is a simplified schematic block diagram illustrating apparatuses according to the embodiments of the present invention.

### DETAILED DESCRIPTION OF EMBODIMENTS

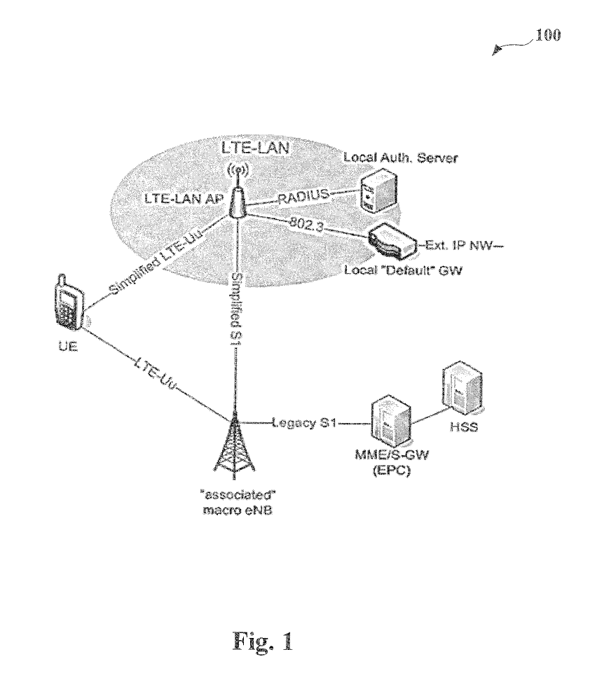

An LTE-LAN (may also referred to as eLAN) technique is a heterogeneous network technique that can be used in a network consisting of an EPS network comprising macro/micro/pico BSs and a LAN comprising wireless APs. In such a heterogeneous network, a UE may have EPS and eLAN connectivity separately or concurrently. In this manner, the eLAN may provide high performance services for wireless communication users with relatively low costs. For example, the UE may have EPS bearer, offloaded EPS bearer and eLAN bearer services. For a better understanding of embodiments of the present invention, below is an introduction regarding this heterogeneous network with reference to FIG. 1.

FIG. 1 illustrates an exemplary heterogeneous network 100 including an LTE-LAN, in which exemplary network entities and interfaces between these entities are illustrated and embodiments of the present application can be practiced. As shown in FIG. 1, the LTE-LAN applies a new LTE-like radio interface as a “simplified LTE-Uu” interface between the UE and LTE-LAN AP. Due to requirement for less CN involvement, the LTE-LAN network according to certain embodiments of the present invention supports a “stand-alone” mode where the LTE-LAN network is working autonomously by providing a basic wireless broadband access with UE traffic routing to a local LAN/IP network directly from an LTE-LAN AP and to the Internet via a default GW of this LAN/IP network. This autonomous “stand-alone” mode operation is useful especially in the case where overlaying macro network service (also termed a wide area service relative to a local area service in the present invention) coverage, e.g., provided by an “associated” macro eNB (also termed a wide area BS in the present invention) as illustrated in FIG. 1, is missing or has poor quality or poor capabilities relative to what the service would need. The local LAN transport network may include an ordinary Ethernet-based LAN, i.e. IEEE 802.3 or any of its modern extensions like Gigabit-Ethernet, as shown in FIG. 1. In general, this stand-alone LTE-LAN operation resembles existing Wi-Fi network solutions except that the radio interface is using said simplified LTE-Uu interface with LTE procedures. The LTE local radio would use LTE physical layer or any of its extensions (e.g., LTE-Advanced) and LTE protocols with possible simplifications compared to a WAN. The LTE-LAN may additionally include new features specifically designed for the local wireless access.

For the autonomous stand-alone mode operation as discussed above, the LTE-LAN network provides means for UE authentication and authorization to use services provided by the LTE-LAN network. This may be implemented by using similar methods as applied in WLAN (IEEE 802.11i) but modified to carry the authentication protocol messages, e.g. EAP encapsulated into LTE Uu RRC messages. In FIG. 1, there is shown an optional local authentication server that may be a RADIUS server or a diameter server like the one used in enterprise networks.

It can be seen that operations of the above heterogeneous network 100 may require separate RRC protocol operations between the UE and the eNB of the legacy network (e.g., LTE or EPS network) and between the UE and the AP of the eLAN. The local RRC procedures are mainly seen necessary to provide radio link management and radio link association of the UE to a serving wireless network node, e.g., the AP. In the WAN, the RRC procedures may serve multitude of more purposes as well. The problem of having two RRC connections simultaneously may result in a potential problem regarding how to coordinate the RRC procedures mutually and achieve better wireless communication in the heterogeneous network.

To address the above potential problems, certain embodiments of the present invention would provide for an efficient way of coordinating RRC procedures in the heterogeneous network without affecting RRC states of the legacy network and their transitions such that the wireless communication in the LTE-eLAN-like heterogeneous network can be performed properly and efficiently. Further, a stable, reliable and high quality performance of local area services through a simplified Uu interface could be guaranteed.

Specifically, certain embodiments of the present invention relate to the RRC states and RRC state change procedures in the LTE-eLAN heterogeneous network environment, where the UE is expected to have both EPS and eLAN connectivity. In such connectivity, the UE may have EPS bearer services, offloaded EPS bearer services and eLAN bearer services according to different RRC states. In the RRC state change procedures, irrespective of whether legacy states are attained conventionally or via an eLAN, embodiments of the present invention enable the legacy ECM states, such as the ECM_CONNECTED and ECM_IDLE states, and the RRC states, such as RRC_CONNECTED and RRC_IDLE states, respectively, to be maintained intacted.

The following are further details regarding RRC states and state transitions according to the embodiments of the present invention.

### RRC States

With respect to the RRC states, the embodiments of the present invention are implemented so that the availability of an eLAN for a heterogeneous LTE or EPS network is inserted as additional opportunities to the RRC states. The two legacy EPS states, i.e., ECM_CONNECTED and ECM_IDLE states, would be maintained according to the present invention. As is known to those skilled in the art, the ECM_CONNECTED state is attained by successful execution of an ATTACH procedure while the ECM_IDLE state is attainable by successful execution of the DETACH procedure.

In regards to a radio network connection with a macro eNB, a UE may be in an RRC state, i.e., an RRC_CONNECTED or RRC_IDLE state. It can be assumed that the UE is in the RRC_IDLE state, whenever it is not in the RRC_CONNECTED state. The RRC states would be further used to determine the LTE_IDLE or LTE_ACTIVE mode of the UE.

According to the embodiments of the present invention, the availability of RRC connection to an eLAN is visible in the following ways:

In the RRC_IDLE state, the UE may have an RRC connection to the eLAN in a breakout or standalone mode only. Due to the RRC_IDLE state, neither EPS bearer services nor EPS connectivity is available for the UE. However, there may be eLAN bearer services and local connectivity available for the UE.

In the RRC_CONNECTED state, the UE may have an RRC connection to an associated eNB of the EPS network, such as the one illustrated in FIG. 1. Due to the RRC_CONNECTED state, the EPS bearer services and EPS connectivity are available for the UE. The EPS RRC connection is established by the RRC connection establishment procedure, which may be executed over the Uu-interface. Alternatively, this procedure may be executed via the serving eLAN according to the present invention. In the latter case, the eLAN connection and its interfaces to the EPS network have to be made available to the UE, so that the communication between the UE and the associated eNB may take place via the eLAN.

### RRC State Transitions

With respect to the RRC state transitions, the RRC protocol state transitions involve a state transition from the RRC_CONNECTED state to the RRC_IDLE state and a state transition from the RRC_IDLE state to the RRC_CONNECTED state. In case a UE has no connection to an eLAN and no RRC connection to the EPS network, the UE would be considered as being in the RRC_IDLE state. While in the RRC_IDLE, the UE may establish an RRC connection to the eLAN, thereby activating an eLAN service. The UE is then in the RRC_IDLE state and the wireless LAN available state. In case the eLAN becomes unavailable, the UE will remain in the RRC_IDLE state but now with the eLAN connection unavailable, i.e., also in the wireless LAN unavailable state.

While in the RRC_IDLE state, the UE may run an RRC connection establishment procedure over the Uu-interface as illustrated in FIG. 1 and transfer to the RRC_CONNECTED state. Alternatively, according to the present invention, the UE may run an RRC connection establishment procedure over the eLAN, and transfer to the RRC_CONNECTED state with the eLAN connection available (i.e., also being in the wireless LAN available state). While in the RRC_CONNECTED state, if the eLAN becomes unavailable, the UE may remain in the RRC_CONNECTED state but now with the eLAN unavailable (i.e., also being in the wireless LAN unavailable state). While being in the RRC_CONNECTED state, the UE may change its connections and bearer services accordingly, as the eLAN becomes available or unavailable and the following opportunities may appear according to the availability of the eLAN:

EPS connection is available over the Uu-interface and no eLAN connection exists;

EPS connection is available over the Uu-interface and eLAN is available; and

EPS connection is available over the eLAN connection but not over the Uu-interface.

In case the RRC connection of the UE will be released, e.g., by an RRC connection release procedure (initiated by the EPS or LTE network), the UE will transfer to the RRC_IDLE state. On the other hand, the UE may transfer from the RRC_CONNECTED state to the RRC_IDLE state and the wireless LAN unavailable state if neither the EPS network nor the eLAN is available to the UE.

In a case where the UE is in the RRC_CONNECTED state and executes the RRC connection release procedure, and in the meantime, the UE has an eLAN connection, then the UE may transfer to the RRC_IDLE state but it may still maintain its eLAN connection for the eLAN bearer services. As discussed previously, this is the case of an eLAN breakout mode (i.e., an autonomous mode) for local bearer services. It is incumbent upon the EPS network, when executing the RRC connection release procedure with the UE having an eLAN connection, to further release the UE's tunneling interface from the EPS to the eLAN for the terminated EPS bearer services.

The RRC states and corresponding state transitions may be summarized in the below Table 1.

TABLE 1

| | | | Possible | | |
|---|---|---|---|---|---|
| | eLAN | | connection and | Offloaded | Local |
| LTE RRC State | availability | EPS State | service instances | services | services |
| RRC_CONNECTED | eLAN | ECM_CONNECTED | UE is connected to | N/A | N/A |
| | unavailable | | a macro cell and | | |
| | | | EPS service(s) | | |
| | | | is active. | | |
| RRC_CONNECTED | eLAN | ECM_CONNECTED | UE has EPS | Possible | may be |
| | available | | service(s) active. | | active or |
| | | | EPS bearer | | inactive |
| | | | services may be | | |
| | | | offloaded via | | |
| | | | eLAN. | | |
| RRC_IDLE | eLAN | ECM_IDLE | UE is camping on | N/A | N/A |
| | unavailable | | a macro cell other | | |
| | | | than eLAN cell(s). | | |
| RRC_IDLE | eLAN | ECM_IDLE | UE is camping on | No | may be |
| | available | | a macro cell or | | active |
| | | | may be camping | | or |
| | | | on eLAN cell(s). | | inactive |
| | | | No EPS services | | |
| | | | are active. | | |

It should be noted, also as mentioned before, that the items “eLAN unavailable” and “eLAN available” as listed above represent that the eLAN is not available or is undetectable and the UE has deactivated or activated a local area service provided by the eLAN, respectively. It is also understood that the wide area bearer services, suppose that they have been activated with the wireless WAN (e.g., an LTE or EPS network), can be offloaded only if the eLAN is available to the UE, and the eLAN has an interface to the EPS network. Of course, if the eLAN is unavailable, the eLAN need not have an interface to the EPS network or the UE is in the RRC_IDLE state, it is unlikely to have the wireless wide area bearer service offloaded via the eLAN.

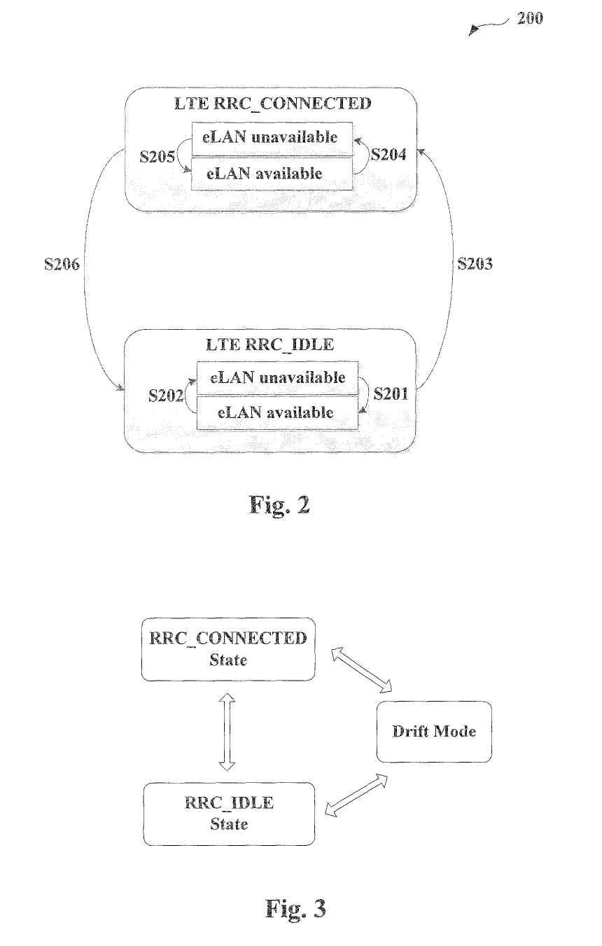

The foregoing has discussed the RRC states and their mutual transitions within the scope of the exemplary embodiments of the present invention, how a UE proceeds with these RRC states and state transitions will be detailed and elaborated in the following with reference to FIG. 2.

FIG. 2 schematically illustrates state transitions 200 of a UE in the heterogeneous network as illustrated in FIG. 1, including corresponding changes of LTE RRC states. As illustrated in FIG. 2, new states of “eLAN unavailable” and “eLAN available” are added and transferred between each other under the LTE RRC_CONNECTED and the LTE RRC_states, respectively. For better understanding and easy discussion of the present invention, the functions of the UE in the heterogeneous network would be exemplarily described in the following four scenarios: (1) the UE functions in an LTE RRC_IDLE and eLAN unavailable state; (2) the UE functions in an LTE RRC_IDLE and eLAN available state; (3) the UE functions in an LTE RRC_CONNECTED and eLAN available state; and (4) the UE functions in an LTE RRC_CONNECTED and eLAN unavailable state.

UE functions in LTE RRC_IDLE and eLAN unavailable state

The UE's RRC_IDLE state procedure may remain unchanged in the legacy system, i.e., the UE may camp on cells of different radio access network technologies (e.g., GERAN WCDMA, HSPA, LTE, LTE-A or the like) which are possibly available in the EPS network. The idle state mobility preferences may be defined by e.g., the EPS network.

When scanning, decoding and camping on the EPS network (i.e., transferring into the LTE RRC_IDLE state), the UE may additionally have eLAN scanning and search functions enabled and search frequencies available for the eLAN(s) in other than the legacy IMT spectrum. These frequencies may include but are not limited to 3.5 GHz, local white spaces frequencies and unlicensed spectrum. It is possible that the cells of the EPS network and the cells of the eLAN are available in the same frequency bands and even in the same carrier frequency positions, if practical.

In the eLAN searching process as above, the UE may search for cells of a specific eLAN having a given name, a given identity or a PLMNID association to the EPS network. Depending on the possible preferences, the UE may search for a single eLAN or possibly multiple eLANs so as to select a best one of them.

The approaches for the eLAN detection and selection may by implemented in a manner of at least one of the following:

UE conducting the eLAN detection and selection independently;

EPS network assisting the UE in the eLAN detection and selection by e.g., an RRC eLAN MobilityConf Information Element; and

EPS network operator assisting the UE in the eLAN detection and selection by e.g., an ANDSF or other Management Object provided from a network server, or otherwise programmed or configured in to the UE device.

UE Functions in LTE RRC_IDLE and eLAN Available State

After the detection, selection and successful access to the eLAN, i.e., transferring from the state of “eLAN unavailable” to “eLAN available,” as illustrated at step S201, the UE may operate in the following manners while remaining in the LTE RRC_IDLE state:

UE may establish autonomous local bearer services via the local connectivity to access other networks e.g., Internet/Intranet;

UE may, by the assistance of the available eLAN or the serving eLAN, receive EPS system information from the associated eNB of the LTE network. This appears feasible if the EPS network has an interface (simplified S1 or alike) with the eLAN network.

Based upon the received system information, the UE may decide to access to the LTE network. In case the UE will make an attempt to connect to the LTE network via the eLAN, it has to execute a legacy RRC_ConnectionRequest procedure with the associated eNB in order to change to the LTE RRC_Connected state (a state transition as illustrated by step S203). This operation may not need RACH procedures as such, because the radio access to the eLAN exists already and the EPS interfaces may have been established (or can now be established) for the eLAN. Hence, the available eLAN access has to support the transport of RRC messages between the UE and the associated eNB for the connection establishment.

Additionally, as illustrated at step S202, the UE may transfer back to the “eLAN unavailable” state while staying in the LTE RRC_IDLE state if the UE decides to deactivate an activated local area service, or if the UE moves out of the coverage of the serving eLAN.

UE Functions in LTE RRC CONNECTED and eLAN Available State

After the successful execution of the LTE RRC connection establishment procedure, i.e., a transfer of the LTE RRC_IDLE state to the LTE RRC_CONNECTED state as illustrated by step S203, and after the successful authentication, the UE may setup EPS default bearer and EPS dedicated bearers to the PDN gateway under the control of MME procedures and UE context handling procedures. UE may complete the above various procedures via the Uu air interface as illustrated in FIG. 1 or via the eLAN according to the present invention.

In case the UE has transferred into the LTE RRC_Connected state via the Uu air interface and then the eLAN becomes available, the associated eNB may decide to establish the (simplified S1) interface to the eLAN and may further decide to transfer either the RRC procedures or any one of or any set of selected bearers or both of the UE to be routed (or to be served) via the available eLAN.

In case the RRC connection establishment has been performed via the available eLAN and the UE detects LTE macro cells over the Uu air interface, then the UE may report the LTE macro cells to the associated macro eNB, which in turn may redirect the LTE RRC procedures to the macro cell via the Uu air interface and may selectively redirect the BPS bearers to the macro cell via the Uu-interface. If there are no RRC connection services nor EPS bearer services provided by routing via the eLAN, the Si connection between the BPS and the eLAN may also be terminated for the UE. In case this direction and termination are performed by the same associated eNB, it may not be necessary to perform a handover procedure. However, in case the RRC connection would be transferred from the associated eNB to another eNB of the LTE network, an ordinary handover procedure will take place between the associated eNB and the other eNB providing Uu-coverage in the above described transition.

In case the associated eNB transfers the LTE RRC connection from being routed via the eLAN to take place directly over the Uu air interface, the UE and the serving eNB need to commonly understand that the RRC message transactions have been transferred from one route to another. This may be implemented by changing an RRC transaction identifier from one to another. In an embodiment of the present invention, the RRC transaction identifier change may be conducted at a time when all on-going RRC procedures are terminated either successfully or to a definite failure case. In another embodiment of the present invention, even an ongoing RRC transaction could be moved from one route to another. This would require signaling for mapping one RRC transaction identifier to another one in order for the UE and eNB to continue with the same transaction that has been shortly interrupted due to the unavailability of the eLAN and would be recovered by message transfer via the Uu interface.

It can be seen from the foregoing that in this LTE_RRC_Connected and eLAN available state, the UE may have EPS bearer services in control of the EPS network and autonomous local bearer services in control of the eLAN. These bearer services are managed independently.

UE Functions in LTE RRC_CONNECTED and eLAN Unavailable State

While operating in the LTE RRC_Connected state, the UE may transfer from the state “eLAN available” to “eLAN unavailable” as illustrated by step S204 when the eLAN becomes unavailable due to the fact that UE may move out of the coverage of the eLAN or the eLAN is undetectable. In other words, the UE will have to terminate the local bearer services provided by the eLAN. Also the offloaded EPS bearer services have to be transferred to be served over the Uu-interface or alternatively they have to be terminated, and hereafter the UE specific S1 interface between the eLAN and associated eNB will also be terminated.

In case the LTE RRC connection has been serving over the Uu air interface and the eLAN becomes unavailable, the UE will terminate the local bearer services and then transfer into the eLAN unavailable state without causing any impacts on the operations of the UE in the EPS network. In case the RRC connection has been established via the eLAN, the UE may execute procedures to transfer the EPS connection from being routed via the eLAN to be routed via the Uu air interface. This may involve procedures similar to those discussed in the part “UE functions in an LTE RRC_CONNECTED and eLAN available state.”

In case the LTE RRC connection has been established via the eLAN and LTE cells are not detected over the Uu air interface, the UE preferably has to execute the RRC_ConnectionRelease procedure with the associated eNB before disconnecting from the eLAN. In this case, UE may deliver measurement reports to the associated eNB indicating that all measured cells are out of range, and the associated eNB may decide to initiate the RRC_ConnectionRelease procedure with the UE.

In case the eLAN suddenly disables the UE being connected to the eLAN, e.g., eLAN abruptly cancels the access authorization or the coverage of the eLAN abruptly disappears, the UE may not be able to execute the LTE RRC_ConnectionRelease procedure properly but just disappears from the LTE network. In this case, the UE may try to execute LTE RRC re-establishment procedures with any of the LTE eNBs over the Uu air interface. This kind of RRC re-establishment procedure may end up successfully or terminate to a defined failure case, or it may end to a timeout if the UE cannot find any strong enough eNB cells to connect. The LTE network is fully capable of handling the UE disappearing from the LTE network suddenly, even though a preferred way is to successfully execute the RRC_ConnectionRelease procedure and change to the LTE RRC_IDLE state, as illustrated by step S206.

After disconnecting from the eLAN, the UE may proceed according to the descriptions in the part “UE functions in an LTE RRC_IDLE and eLAN unavailable state,” i.e., continue searching and detecting other eLAN(s), or any EPS cells. Alternatively, the UE may turn off its eLAN related search and detection functions and just stay in searching, detecting and camping on the genuine LTE network according to the LTE RRC_IDLE state procedures, until it may change to the LTE RRC_CONNECTED state procedures, if feasible. Of course, when in the LTE RRC_CONNECTED state, the UE may detect a new eLAN and transfer into the eLAN available state as illustrated by step S205.

It can be expected that in some geographical areas multiple independent eLAN networks may be present. In this case, the UE may search any specific one of them or arbitrarily search any one of them. The eLAN may have a preference in some other metric than their coverage, e.g., in their level of trust for the UE or for the EPS, or in terms of their recognizability or anonymity.

FIG. 3 schematically illustrates state transitions of the UE in the heterogeneous network, in which a drift mode is introduced, according to an embodiment of the present invention. As illustrated in FIG. 3, a UE may transfer into a drift mode from an RRC_CONNECTED or RRC_IDLE state (or mode). The drift mode defined by embodiments of the present invention is a mode in which the UE may detect that an eLAN is available and then activate a wireless local service provided by the eLAN. Once the UE deactivates the activated local service, then the UE may return to the RRC_CONNECTED or RRC_IDLE state depending on the RRC state of the UE with the LTE or EPS network. It is to be understood that the entry of the UE into the drift mode is also independent of the concurrent RRC state of the user equipment.

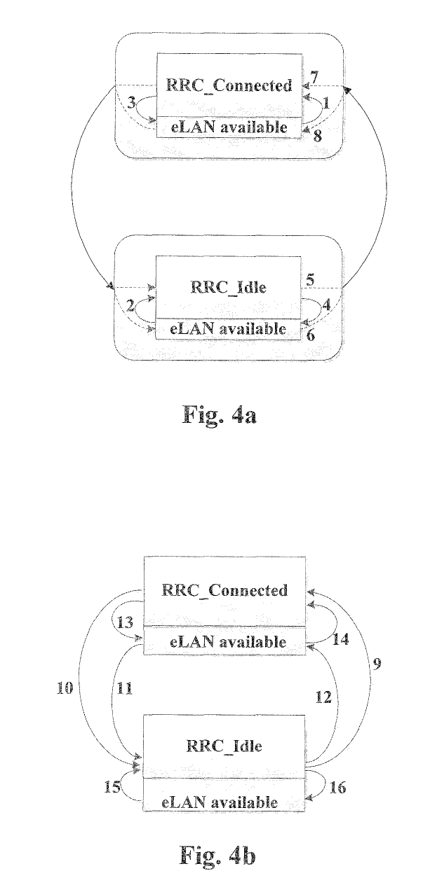

FIG. 4a schematically illustrates alternatives regarding state transitions of the UE as illustrated in FIG. 2 according to an embodiment of the present invention. Unlike the state transitions as illustrated in FIG. 2, the eLAN unavailable state under the RRC_CONNECTED state or RRC_IDLE state is omitted. However, the UE can be considered as being in the eLAN unavailable state whenever it is not in the eLAN available state. Therefore, arrows 1 and 2 pointing out from the block of the eLAN available state into the RRC_CONNECTED state and RRC_IDLE state, respectively, indicate that the UE transfers to the eLAN unavailable state. Likewise, arrows 3 and 4 pointing into the block of the eLAN available state indicate that the UE transfers into the eLAN available state without changes of the concurrent RRC states.

In addition to performance of eLAN state transitions without changes of the RRC states, FIG. 4a also illustrates, by dashed arrows, the transferring of the RRC states together with different eLAN states. Take arrows 5-8 as examples, the arrows 5 and 7 indicate that the UE transfers from the RRC_IDLE state with the eLAN unavailable state into the RRC_CONNECTED state with the eLAN unavailable state. The arrows 5 and 8 indicate that the UE transfers from the RRC_IDLE state with the eLAN unavailable state into the RRC_CONNECTED state with the eLAN available state. Likewise, the arrows 6 and 7 indicate that the UE transfers from the RRC_IDLE state with the eLAN available state into the RRC_CONNECTED state with the eLAN unavailable state. The arrows 6 and 8 indicate that the UE transfers from the RRC_IDLE state with the eLAN available state into the RRC_CONNECTED state with the eLAN available state. Similarly, the UE may transfer from the RRC_CONNECTED state into the RRC_IDLE state with a corresponding eLAN available state or eLAN unavailable state depending on the availability of the eLAN. For a concise purpose, a further description regarding the transferring from the RRC_CONNECTED state into the RRC_IDLE state is omitted herein. The state transitions as described herein may be composed of different amounts of message exchange and different number of procedures relative to the networks. Some state transitions may be light and fast, whereas other state transitions may be slower or may require execution of more messages or more complex messages. Security procedures as enablers for at least some of the state transitions may also cause processing and communication needs, as common in a communication system.

FIG. 4b schematically illustrates alternatives regarding state transitions of the UE as illustrated in FIG. 2 according to another embodiment of the present invention. It can be seen that the state transitions as illustrated in FIG. 4b are similar to those in FIG. 4a. For example, arrows 9 and 10 indicate the RRC state transitions of the UE under the eLAN unavailable state while arrows 11 and 12 indicate that the UE transfers from the RRC Connected state with the eLAN available state into the RRC_Idle state with the eLAN unavailable state and that the UE transfers from the RRC_Idle state with the eLAN unavailable state into the RRC_Connected state with the eLAN available state, respectively. Likewise, arrows 13 and 14 indicate the eLAN state transitions of the UE under the RRC_Connected state while arrows 15 and 16 indicate the eLAN state transitions of the UE under the RRC_Idle state.

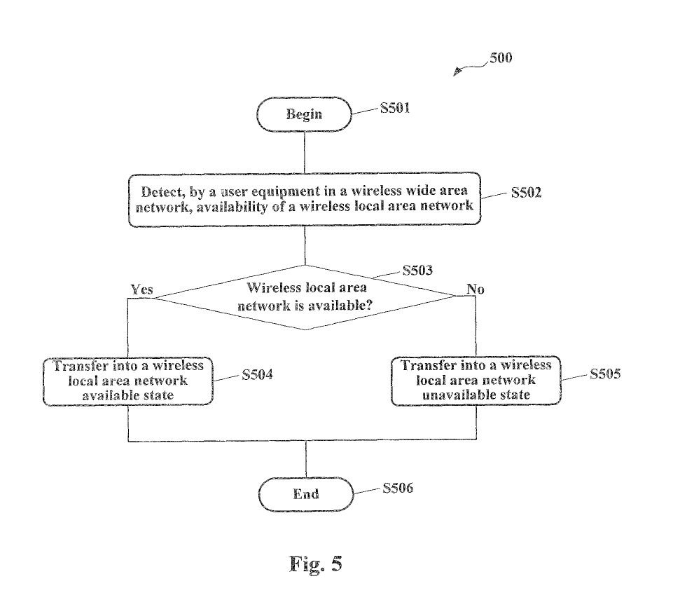

FIG. 5 is a flow chart schematically illustrating a method 500 for wireless communication in the heterogeneous network as illustrated in FIG. 1 according to an embodiment of the present invention. As illustrated in FIG. 5, the method 500 begins at step S501 and proceeds to step S502, at which the method 500 detects, by a UE in a wireless WAN (e.g., an LTE or EPS network), availability of a wireless LAN (i.e., an eLAN). In an embodiment, the availability of the wireless LAN may be detected based upon a predetermined identifier or assistance from the wireless WAN. In an embodiment, an autonomous detection of the wireless LAN is feasible.

Then, at step S503, the method 500 determines if the wireless LAN is available. This can be done, for example, by searching the network, making an access attempt and receiving a communication link identity from the wireless LAN. If it is determined that the wireless LAN is available to the UE and access of UE to that network was successful, then the method 500 switches to step S504, at which the method 500 comprises (i.e., makes the UE to transfer into) transferring into a wireless LAN available state. Otherwise, if it is determined that the wireless LAN is unavailable to the UE, then the method 500 switches to step S505, at which the method 500 comprises transferring into a wireless LAN unavailable state. According to the present invention, entry of the UE into the wireless LAN available state or into the wireless LAN unavailable state is independent of a concurrent RRC state of the UE (relative to the wide area EPS network), e.g., an RRC_CONNECTED or RRC_IDLE state. Upon entry into the wireless LAN available state or unavailable state, the method ends at step S506.

Although not shown in FIG. 2, in one embodiment, the transferring into the wireless LAN available state may comprise one of camping on the wireless LAN and activating a wireless local area service provided by the wireless LAN. In another embodiment, the method 500 makes the UE to transfer, subsequent to deactivating the activated wireless local area service, into the wireless LAN available state by camping on the wireless LAN. In another embodiment, activating the wireless local area service may not involve any camping, or camping-like functionality in the local area network as such, but the access procedures are simply involving search and detection functions, following with an access attempt, and further receiving an access identity as a response to the attempt as a sign of successful access.

In an additional embodiment, the method 500 further comprises receiving, via the wireless LAN, system information from the wireless WAN and activating, based upon the system information, a wireless wide area service to transfer into the RRC connected state. Upon entry into the RRC connected state, the method 500 comprises one of the following steps: directly transmitting to or receiving from the wireless WAN the wireless wide area service, and indirectly transmitting to or receiving from the wireless WAN the wireless wide area service at least partly via the wireless LAN.

In one embodiment, the method 500 further comprises activating a wireless wide area service via a direct connection with the wireless WAN to transfer into the RRC connected state and transferring into the wireless LAN available state by activating the wireless local access. In other words, the UE transfers into a dual connected mode. Afterwards, the UE may select to directly transmit to or receive from the wireless WAN the wireless wide area service or the UE may select to indirectly transmit to or receive from the wireless WAN the wireless wide area service at least partly via the wireless LAN. This selection may be based on bearer, or per traffic flow type.

In a further embodiment, the wireless wide area service is related to at least one RRC transaction and indirectly transmitted to or received from the wireless WAN via the wireless LAN, and the method 500 comprises maintaining, in response to disconnecting the wireless LAN from the wireless WAN, at least one RRC transaction by mapping or changing an identifier thereof.

In an embodiment, the method 500 further comprises activating a wireless wide area service via a direct connection with the wireless WAN to transfer into the RRC connected state. After transferring into the RRC connected state, the UE may transfer into the wireless LAN unavailable state or available state in dependence on the availability of the wireless LAN.

In yet another embodiment, the method 500 comprises activating a wireless wide area service via the wireless LAN to transfer into the RRC connected state and performing, prior to disconnecting from the wireless LAN, an RRC connection release procedure with the wireless WAN if no wide area cell is detected to continue the connectivity service. This may occur in a case that the wireless LAN is becoming unavailable and the UE delivered measurement reports to the associated eNB to indicate that all cells are out of range (i.e., no cells detected over the Uu-interface).

In a further embodiment, the method 500 further comprises deactivating the activated wireless wide area service via the wireless LAN to transfer into the RRC idle state. After that, the UE may transfer into the wireless LAN available or unavailable state according to the availability of the wireless LAN.

According to embodiments of the present invention, the wireless LAN may be an eLAN constructed under an LTE system and comprises at least one wireless local area AP for serving the UE, and the wireless WAN is an LTE network or an EPS network and comprises at least one macro eNode B.

Based upon the method 500 as performed by the UE, the legacy LTE state or EPS RRC state can be maintained intacted without being affected by the UE having access to the eLAN. Hence, the RRC states and their state transitions can be well coordinated in the heterogeneous network. Thereby, the UE may operate in a highly-efficient manner, especially in the eLAN.

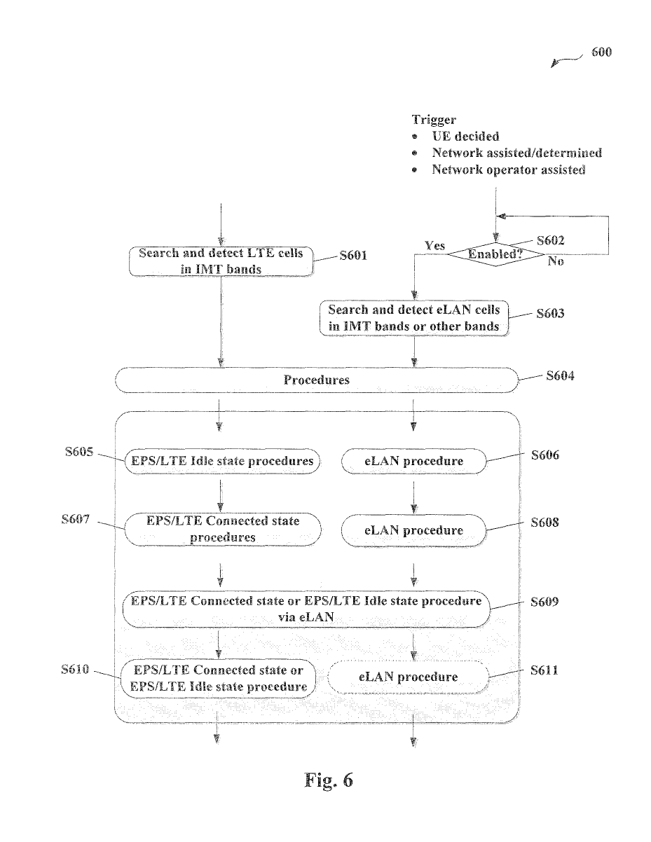

FIG. 6 is a flow chart schematically illustrating a method 600 for wireless communication in the heterogeneous network according to another embodiment of the present invention. As illustrated in FIG. 6, at step S601, a UE may search and detect LTE cells in the IMT bands. At step S602, it is determined whether the UE is enabled or triggered to detect the availability of any eLANs. As discussed before, the triggering herein can be implemented in a UE decided, network assisted/determined, or network operator assisted manner. Once the UE is enabled, it may, at step S602, search and detect any eLAN cells in IMT bands or other bands such as those discussed in the part “UE functions in LTE RRC_IDLE and eLAN unavailable state.”

At step S604, once the UE has access to the LTE/EPS network and eLAN, it may perform the procedures according to the embodiments of the present invention. As illustrated, it may perform EPS/LTE (RRC) IDLE state procedure, i.e., camping on the EPS/LTE network and not activating wide area services. In the meanwhile, the UE may also perform an eLAN procedure at step S606, which might include operating in an available state or unavailable state. At step S607, the UE may transfer from the EPS/LTE IDLE state into the EPS/LTE (RRC) CONNECTED state over time. Concurrently, the UE may perform the eLAN procedure at step S608. Afterwards, at step S609, the UE may be in the EPS/LTE CONNECTED state transferred from the EPS/LTE IDLE state via the eLAN. Alternatively, the UE may be in the EPS/LTE IDLE state transferred from the EPS/LTE CONNECTED state via the eLAN. Once the UE decides to release the connection with the eLAN or the eLAN is unavailable, the UE may once again perform, at step S610, the EPS/LTE Connected state or Idle state procedure directly with the eNB instead of indirectly via the eLAN. On the other hand, at step S611, the UE may perform the eLAN procedure again dependent on the availability of the eLAN. Because the above mentioned procedures have been discussed in detail before, a further description is omitted herein for a concise purpose.

The foregoing has discussed the embodiments of the present invention in one possible step order, it should be noted that this order is merely illustrative of the present invention. A person skilled in the art can understand that the embodiments of the present invention can be carried out in any suitable orders. For example, as for a selected time point, the UE may be in an eLAN available state and an LTE RRC_CONNECTED state at the outset and then transfer into an eLAN unavailable state while remaining in the LTE RRC_CONNECTED state. As time passes, the UE may transfer into the LTE RRC IDLE state while keeping the eLAN unavailable state intacted. After a while, the UE may transfer into the LTE RRC_CONNECTED state and the eLAN available state. It is apparent that the state changes of the UE in the eLAN are highly flexible and independent of the RRC state changes in the LTE or EPS network. Thereby, good coordination of RRC states in the heterogeneous network can be realized without substantively affecting operations of the legacy network.

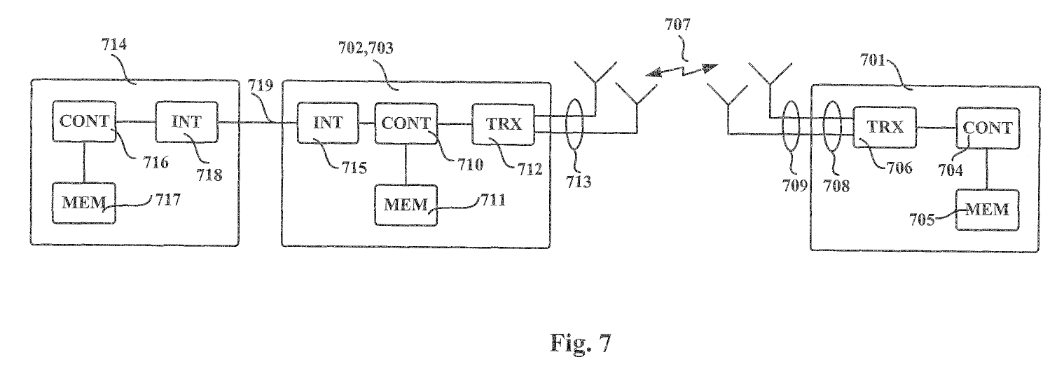

FIG. 7 is a simplified schematic block diagram illustrating apparatuses according to an embodiment of the present invention. As illustrated in FIG. 7, a UE 701 is located in the coverage of a radio network node 702 or 703 and is configured to be in connection with the radio network node 702 or 703. The UE 701 comprises a controller 704 operationally connected to a memory 705 and a transceiver 706. The controller 704 controls the operation of the UE 701. The memory 705 is configured to store software and data. The transceiver 706 is configured to set up and maintain a wireless connection 707 to the radio network node 702 or 703. The transceiver 706 is operationally connected to a set of antenna ports 708 connected to an antenna arrangement 709. The antenna arrangement 709 may comprise a set of antennas. The number of antennas may be one to four, for example. The number of antennas is not limited to any particular number. The UE 701 may also comprise various other components, such as a user interface, camera, and media player. They are not displayed in the figure due to simplicity.

The radio network node 702 or 703, such as an LTE base station (or eNB) or LTE-LAN AP included in an eLAN, comprises a controller 710 operationally connected to a memory 711, and a transceiver 712. The controller 710 controls the operation of the radio network node 702 or 703. The memory 711 is configured to store software and data. The transceiver 712 is configured to set up and maintain a wireless connection to the UE 701 within the service area of the radio network node 702 or 703. The transceiver 712 is operationally connected to an antenna arrangement 713. The antenna arrangement 713 may comprise a set of antennas. The number of antennas may be two to four, for example. The number of antennas is not limited to any particular number. The radio network node 702 or 703 may be operationally connected (directly or indirectly) to another CN or LAN network element 714 of the communication system, such as an RNC, an MME, an MSC server (MSS), an MSC, an RRM node, a gateway GPRS support node, an OAM node, an HLR, a VLR, a serving GPRS support node, a GW, and/or a server, via an interface 715. The network node 714 comprises a controller 716 operationally connected to a memory 717, and an interface 718. The controller 716 controls the operation of the network node 714. The memory 717 is configured to store software and data. The interface 718 is configured to connect to the radio network node 702 or 703 via a connection 719. The embodiments are not, however, restricted to the network given above as an example, but a person skilled in the art may apply the solution to other communication networks provided with the necessary properties. For example, the connections between different network elements may be realized with IP connections.

Although the apparatus 701, 702, 703, or 714 has been depicted as one entity, different modules and memory may be implemented in one or more physical or logical entities. The apparatus may also be a user terminal which is a piece of equipment or a device that associates, or is arranged to associate, the user terminal and its user with a subscription and allows a user to interact with a communication system. The user terminal presents information to the user and allows the user to input information. In other words, the user terminal may be any terminal capable of receiving information from and/or transmitting information to the network, connectable to the network wirelessly or via a fixed connection. Examples of the user terminals include a personal computer, a game console, a laptop (a notebook), a personal digital assistant, a mobile station (mobile phone), a smart phone, a communicator, a tablet or a pad.

The apparatus 701, 702, 703, or 714 may generally include a processor, controller, control unit or the like connected to a memory and to various interfaces of the apparatus. Generally the processor is a central processing unit, but the processor may be an additional operation processor. The processor may comprise a computer processor, application-specific integrated circuit (ASIC), field-programmable gate array (FPGA), and/or other hardware components that have been programmed in such a way to carry out one or more functions of an embodiment.

The memory 705, 711, or 717 may include volatile and/or non-volatile memory and typically stores content, data, or the like. For example, the memory 705, 711, or 717 may store computer program code such as software applications (for example for detecting the availability of the wireless LAN and making the UE to transfer into different wireless LAN or WAN states) or operating systems, information, data, content, or the like for a processor to perform steps associated with operation of the apparatus 701, 702, 703 or 714 in accordance with embodiments. The memory may be, for example, a random access memory (RAM), a hard drive, or other fixed data memories or storage devices. Further, the memory, or part of it, may be removable memory detachably connected to the apparatus.

The techniques described herein may be implemented by various means so that an apparatus implementing one or more functions of a corresponding mobile entity described with an embodiment comprises not only prior art means, but also means for implementing the one or more functions of a corresponding apparatus described with an embodiment and it may comprise separate means for each separate function, or means may be configured to perform two or more functions. For example, these techniques may be implemented in hardware (one or more apparatuses), firmware (one or more apparatuses), software (one or more modules), or combinations thereof. For a firmware or software, implementation can be through modules (e.g., procedures, functions, and so on) that perform the functions described herein. The software codes may be stored in any suitable, processor/computer-readable data storage medium(s) or memory unit(s) or article(s) of manufacture and executed by one or more processors/computers. The data storage medium or the memory unit may be implemented within the processor/computer or external to the processor/computer, in which case it can be communicatively coupled to the processor/computer via various means as is known in the art.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

1-28. (canceled)

29. A method, comprising:
detecting, by a user equipment in a wireless wide area network, availability of a wireless local area network;
transferring into a wireless local area network available state if the wireless local area network is available; and
transferring into a wireless local area network unavailable state if the wireless local area network is unavailable,
wherein the transferring into the wireless local area network available or unavailable state is independent of a concurrent radio resource control state of the user equipment.

30. The method as recited in claim 29, wherein the detecting availability of the wireless local area network comprises detecting the wireless local area network based upon a predetermined identifier or assistance information from the wireless wide area network.

31. The method as recited in claim 29, wherein the transferring into the wireless local area network available state comprises one of the following:
camping on the wireless local area network; and
activating a wireless local area service provided by the wireless local area network.

32. The method as recited in claim 31, further comprising:
transferring, subsequent to the activating the wireless local area service provided by the wireless local area network, into a drift mode which is independent of the concurrent radio resource control state of the user equipment.

33. The method as recited in claim 31, further comprising:
transferring, subsequent to deactivating the activated wireless local area service, into the wireless local area network available state.

34. The method as recited in claim 29, wherein the radio resource control state of the user equipment is one of a radio resource control connected state and a radio resource control idle state in the wireless wide area network.

35. The method as recited in claim 34, further comprising:
receiving, via the wireless local area network, system information from the wireless wide area network;
activating, based upon the system information, a wireless wide area service to transfer into the radio resource control connected state; and
at least one of the following:
directly transmitting to or receiving from the wireless wide area network the wireless wide area service; and
indirectly transmitting to or receiving from the wireless wide area network the wireless wide area service at least partly via the wireless local area network.

36. The method as recited in claim 34, further comprising:
activating a wireless wide area service via a direct connection with the wireless wide area network to transfer into the radio resource control connected state;
transferring into the wireless local area network available state by activating the wireless local area service; and
at least one of the following:
directly transmitting to or receiving from the wireless wide area network the wireless wide area service; and
indirectly transmitting to or receiving from the wireless wide area network the wireless wide area service at least partly via the wireless local area network.

37. The method as recited in claim 34, further comprising:
activating a wireless wide area service via a direct connection with the wireless wide area network to transfer into the radio resource control connected state; and
one of the following:
transferring into the wireless local area network unavailable state; and
transferring into the wireless local area network available state.

38. The method as recited in claim 34, further comprising:
activating a wireless wide area service via the wireless local area network to transfer into the radio resource control connected state; and
performing, prior to disconnecting from the wireless local area network, a radio resource control connection release procedure with the wireless wide area network if no wide area cell is detected.

39. An apparatus, comprising:
at least one processor; and
at least one memory including compute program instructions,
wherein the at least one memory and computer program instructions are configured to, with the at least one processor, cause the apparatus at least to:
detect, in a wireless wide area network, availability of a wireless local area network;
transfer into a wireless local area network available state if the wireless local area network is available; and
transfer into a wireless local area network unavailable state if the wireless local area network is unavailable,
wherein the transferring into the wireless local area network available or unavailable state is independent of a concurrent radio resource control state of the apparatus.

40. The apparatus as recited in claim 39, wherein the at least one memory and computer program instructions are further configured to, with the at least one processor, cause the apparatus at least to:
detect the availability of the wireless local area network based upon a predetermined identifier or assistance information from the wireless wide area network.

41. The apparatus as recited in claim 39, wherein the at least one memory and computer program instructions are further configured to, with the at least one processor, cause the apparatus in response to transfer into the wireless local area network available state, at least
to perform one of the following:
camp on the wireless local area network; and
activate a wireless local area service provided by the wireless local area network.

42. The apparatus as recited in claim 41, wherein the at least one memory and computer program instructions are further configured to, with the at least one processor, cause the apparatus at least to:
transfer, subsequent to the activating the wireless local area service provided by the wireless local area network, into a drift mode which is independent of the concurrent radio resource control state of the apparatus.

43. The apparatus as recited in claim 39, wherein the at least one memory and computer program instructions are further configured to, with the at least one processor, cause the apparatus at least to:
transfer, subsequent to deactivating the activated wireless local area service, into the wireless local area network available state.

44. The apparatus as recited in claim 39, wherein the radio resource control state of the apparatus is one of a radio resource control connected state and a radio resource control idle state in the wireless wide area network.

45. The apparatus as recited in claim 44, wherein the at least one memory and computer program instructions are further configured to, with the at least one processor, cause the apparatus at least to:
receive, via the wireless local area network, system information from the wireless wide area network;
activate, based upon the system information, a wireless wide area service to transfer into the radio resource control connected state; and
at least one of the following:
directly transmit to or receive from the wireless wide area network the wireless wide area service; and
indirectly transmit to or receive from the wireless wide area network the wireless wide area service at least partly via the wireless local area network.

46. The apparatus as recited in claim 44, wherein the at least one memory and computer program instructions are further configured to, with the at least one processor, cause the apparatus at least to:
activate a wireless wide area service via a direct connection with the wireless wide area network to transfer into the radio resource control connected state;
transfer into the wireless local area network available state by activating the wireless local area service; and
at least one of the following:
directly transmit to or receive from the wireless wide area network the wireless wide area service; and
indirectly transmit to or receive from the wireless wide area network the wireless wide area service at least partly via the wireless local area network.

47. The apparatus as recited in claim 44, wherein the at least one memory and computer program instructions are further configured to, with the at least one processor, cause the apparatus at least to:
activate a wireless wide area service via a direct connection with the wireless wide area network to transfer into the radio resource control connected state; and
one of the following:
transfer into the wireless local area network unavailable state; and
transfer into the wireless local area network available state.

48. A computer program product, comprising at least one non-transitory computer readable storage medium having a computer readable program code portion stored thereon, the computer readable program code portion comprising:
program code instructions for detecting, by a user equipment in a wireless wide area network, availability of a wireless local area network;
program code instructions for transferring into a wireless local area network available state if the wireless local area network is available; and
program code instructions for transferring into a wireless local area network unavailable state if the wireless local area network is unavailable,
wherein the transferring into the wireless local area network available or unavailable state is independent of a concurrent radio resource control state of the user equipment.
